(19) United States
(12) Patent Application Publication
(10) Pub. No.: US 2010/0007164 A1
(43) Pub. Date: Jan. 14, 2010

(54) Universal sleeve for T-stakes in a flatbed trailer sidewall system

(75) Inventor: Michael R. Harrison, Tallmadge, OH (US)

Correspondence Address: Edward G. Greive;Renner, Kenner, Greive, Bobak, Taylor & Weber, Fourth Floor, First National Tower, Akron, OH, 44308-1456, US

(73) Assignee: Hapco Inc. (d/b/a Tarpco)

(21) Appl. No.: 12/217,886

(22) Filed: Jul. 10, 2008

(51) Int. Cl. B62D 39/00

(52) U.S. Cl. 296/43

(57) ABSTRACT

A sidewall system for receipt by pockets of a flatbed trailer includes a T-stake having a post portion and a wall panel retaining portion. A sleeve has a body of a selected size to be received in the pocket of the flatbed trailer and has a channel sized to receive the post portion of the T-stake. The sleeve may also include an outwardly projecting flange, and may be attached to the post portion of the T-stake. The sleeve is adapted to convert a variety of pocket sizes into a single universal size for receipt of a standard T-stake.

### TECHNICAL FIELD

This invention relates to a universal sleeve used with T-stakes in a flatbed trailer wall system. More specifically, this invention relates to a universal sleeve for attachment to a T-stake and insertion into a pocket in a flatbed trailer.

### BACKGROUND ART

Flatbed trailers are widely used in the trucking industry due, at least in part, to their versatility. The flatbed trailer may be used to haul cargo that does not fit within an enclosed trailer, and it also makes loading some cargo easier, even if that cargo would fit in an enclosed trailer. Frequently, however, it is necessary to provide protection for cargo being hauled by a flatbed trailer to prevent damage from water, wind, and debris. In these instances, flatbed trailers can be converted to enclosed trailers by the use of a temporary sidewall and roof system, transforming the trailer into what is commonly known as a “covered wagon.” These covered wagon systems are well known in the art.

Sidewalls of a covered wagon type trailer typically consist of vertical T-stakes that slide into pockets provided in the trailer and wall panels that fit between retaining members on the T-stakes and rest on the trailer surface. The T-stakes may include a recess to receive an arched member which extends transversely across the width of the trailer. A tarp may then be secured over the arched members to create a roof, thereby creating a substantially waterproof inner area for hauling cargo. In this way the flatbed trailer may be converted to an enclosed trailer so that any type of cargo can be hauled without risk of damaging or losing the cargo.

Although these sidewall systems are generally advantageous, existing T-stakes used in conjunction with flatbed trailer sidewall systems suffer from several disadvantages. Conventionally, a lower portion of the T-stakes is provided without the retaining member so that it will fit into the pockets in the flatbed trailer, with the retaining member resting on the trailer bed when the T-stake has been inserted into the pocket. While this assembly method is effective for the short term, it eventually may lead to serious damage to the bed of the trailer as the retaining member vibrates and shifts during transportation, causing it to gouge the bed. Eventually, after constant and repeated contact between the bed and the lower edge of the retaining member, the bed may become seriously damaged.

In addition, manufacturing T-stakes for use in these flatbed trailer sidewall systems has proven difficult because the pockets provided in the trailers are not uniformly sized. Different trailers have pockets of different sizes. As a result, it has been necessary to produce T-stakes having varying dimensions in order to be able to equip all flatbed trailers with the appropriately sized T-stakes. Not only is this inefficient and cost prohibitive, but it also necessitates that large amounts of inventory be kept on hand in order to convert the different flatbed trailers into covered trailers.

In view of these problems, it is evident that the need exists for a means of allowing for a standardized T-stake of a consistent size, and a mechanism for preventing damage to trailer beds from T-stakes.

### DISCLOSURE OF THE INVENTION

It is thus an object of one aspect of the present invention to provide a universal sleeve that converts varying pocket sizes in trailer beds into a standardized pocket size, thereby allowing for a standardized T-stake size.

It is an object of a further aspect of the present invention to provide a universal sleeve, as above, with a flange to protect the bed of the trailers.

It is an object of an additional aspect of the present invention to provide a universal sleeve, as above, as part of a flatbed trailer sidewall system that is less expensive and more cost effective to manufacture.

These and other objects of the present invention, as well as the advantages thereof over existing prior art forms, which will become apparent from the description to follow, are accomplished by the improvements hereinafter described and claimed.

In general, a universal sleeve made in accordance with the present invention is provided for use with a T-stake and a pocket of a flatbed trailer sidewall system. The sleeve includes a body of a selected size to be received in the pocket of the flatbed trailer. A channel forms an opening in the body which is sized to receive the T-stake therein.

In accordance with another aspect of the invention, a sidewall system for receipt in the pockets of a flatbed trailer is provided. The system includes a T-stake having a post portion and a wall panel retaining portion. A sleeve has a body of a selected size to be received in a pocket of the flatbed trailer, and has a channel sized to receive the post portion of the T-stake.

The invention also relates to a method of constructing a sidewall system for a flatbed trailer having pockets. The method includes the steps of providing a plurality of sleeves of a size selected dependent on the size of the pockets of the flatbed trailer, providing a plurality of T-stakes adapted to fit within a channel in the sleeves which is sized to receive the T-stakes, attaching the sleeves to the T-stakes, and inserting the sleeves and the T-stakes into the pocket of the flatbed trailer.

An additional method of the present invention relates to attaching a sidewall system to a flatbed trailer having pockets and includes the steps of providing a plurality of sleeves having different sized bodies and the same shaped channels, selecting sleeves having a body sized to fit within the pockets of the trailer, and attaching T-stakes shaped like the channel of the selected sleeves to the selected sleeves.

A preferred exemplary sleeve for use with a T-stake of a flatbed trailer sidewall system according to the concepts of the present invention is shown by way of example in the accompanying drawings without attempting to show all the various forms and modifications in which the invention might be embodied, the invention being measured by the appended claims and not by the details of the specification.

### BRIEF DESCRIPTION OF THE DRAWINGS

FIG. 1 is a side elevational view of a flatbed trailer having a sidewall and roofing system according to the concepts of the present invention.

FIG. 2 is a top plan view of a flatbed trailer sidewall system according to the concepts of at least one aspect of the present invention.

FIG. 3 is a partially disassembled perspective view of a portion of the sidewall system in accordance with the present invention.

FIG. 4 is a perspective view of a universal sleeve according to the present invention.

FIG. 5 is a bottom plan view of the universal sleeve of FIG. 4.

FIG. 6 is an exploded perspective view of a T-stake, universal sleeve, and trailer pocket.

FIG. 7 is an assembled perspective view of that which is shown in FIG. 6.

### PREFERRED EMBODIMENT FOR CARRYING OUT THE INVENTION

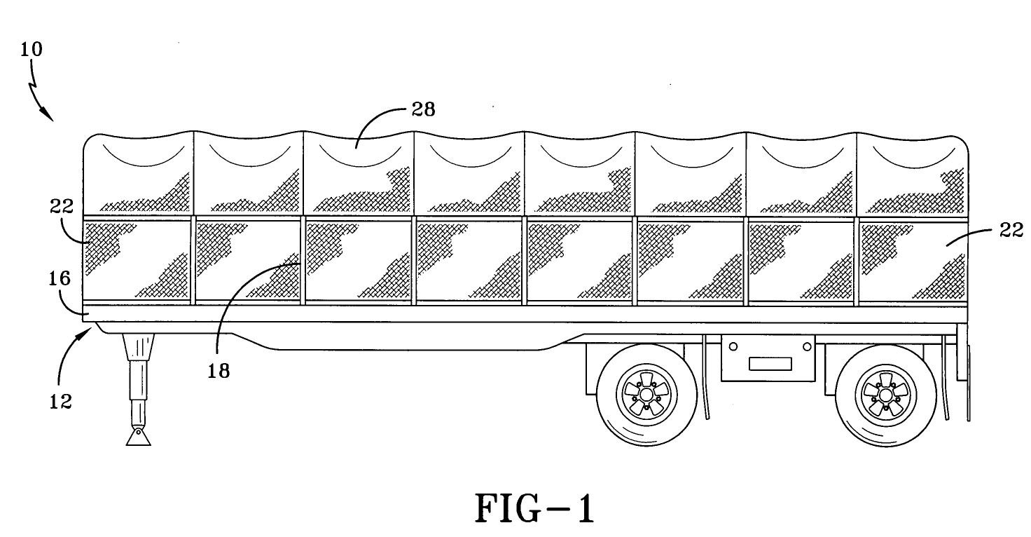

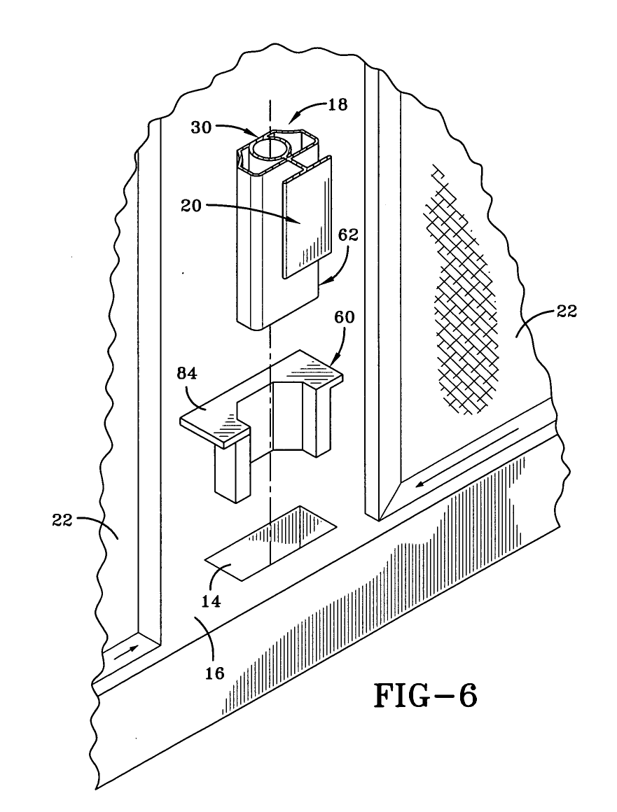

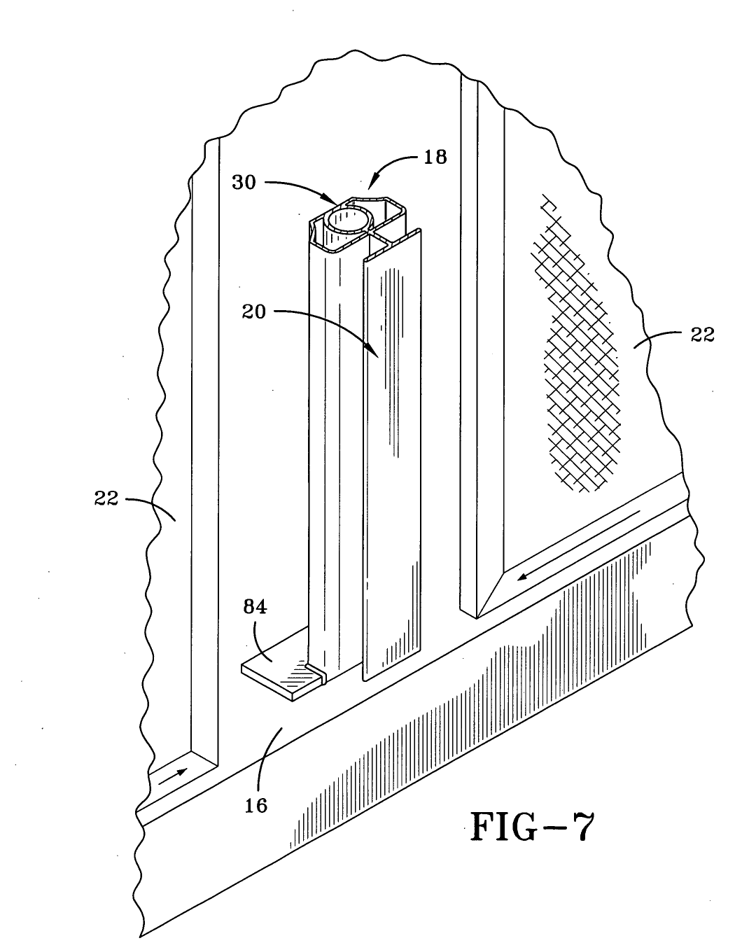

A sidewall and roofing system made in accordance with the present invention is indicated generally by the numeral 10, and is shown in FIG. 1 installed on a flatbed trailer 12. Flatbed trailer 12 may be any conventional flatbed trailer adapted to be pulled by a truck, of which there are a variety of sizes and weight-capacities available. These flatbed trailers 12 may include pockets 14 (see FIG. 6) on beds 16 to receive T-stakes, generally indicated by the numeral 18, therein. The pockets may vary in size and in spacing around the edge of bed 14, but are typically spaced approximately twenty-four inches apart with a width of between approximately 1.50 inches and 1.75 inches and a length of between approximately 2.80 inches and 3.50 inches. T-stakes 16 may be positioned within every pocket 14 of flatbed trailer 12, or, as is more likely, T-stakes 16 may be positioned within every-other pocket around flatbed trailer 12 to allow for an approximately four foot wide space therebetween.

T-stakes 18 are well known in the art of flatbed trailer sidewall systems, are available in a number of various sizes and designs, and may be made from any number of suitable materials known to persons having ordinary skill in the art. The T-stake 18 shown includes a wall panel retaining portion generally indicated by the numeral 20 and a post generally indicated by the numeral 30. Post 30 includes a flat surface 32, a front surface 34, and two opposing side surfaces 36, 38. Post 30 may also include transition surfaces 40, 42 connecting side surfaces 36, 38 with front surface 34. Wall panel retaining portion 20 includes a protruding element 44 extending substantially perpendicular from post 30 at approximately the center of flat surface 32. A retaining flange 46 is positioned substantially perpendicular to protruding element 44, and is positioned approximately centered over protruding element 44. As such, two slots 48, 50 are created, one on either side of protruding element 44. Slots 48, 50 receive wall panels 22 therein and act to secure them in place, with a bottom surface of wall panels 22 resting on bed 16 of flatbed trailer 12, and a top surface of wall panels 22 being approximately level with the top of T-stakes 18.

T-stake 18 also includes a recess 26 in the top portion of post 30 adapted to receive an arched member 24 that extends transversely across trailer bed 16 and is received at its opposite end in another recess 26 of another T-stake 18. Recess 26 may be formed within post 30 in any manner, such as, for example, providing an internal cylinder 54 sized to receive arched member 24. Arched member 24 acts to support a roof tarpaulin 28 that covers and protects flatbed trailer 12. Recess 26 in post 30 may extend the entire length of T-stake 18, or alternatively, may extend a limited length sufficient to accommodate a portion of arched member 24.

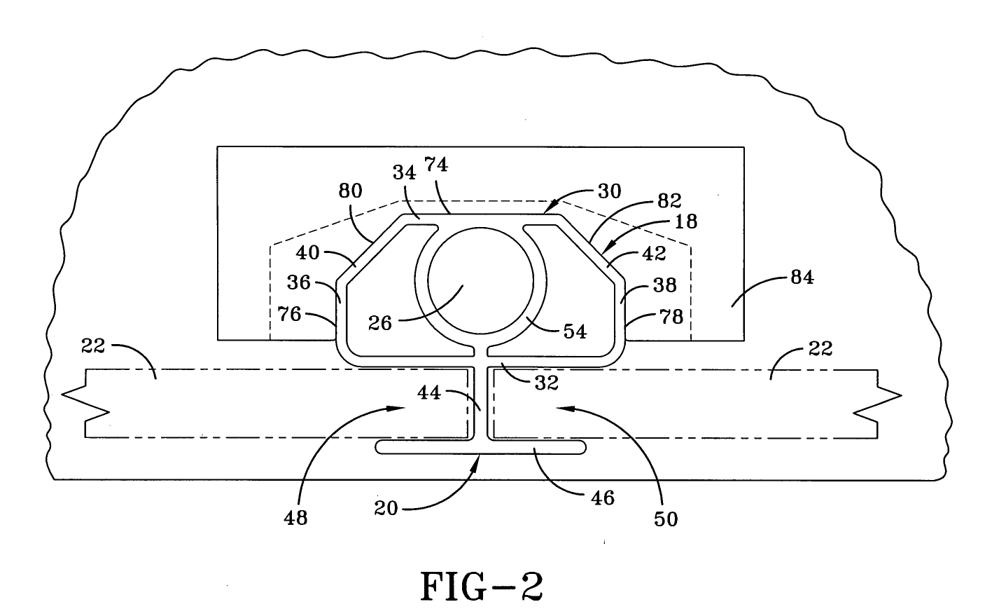

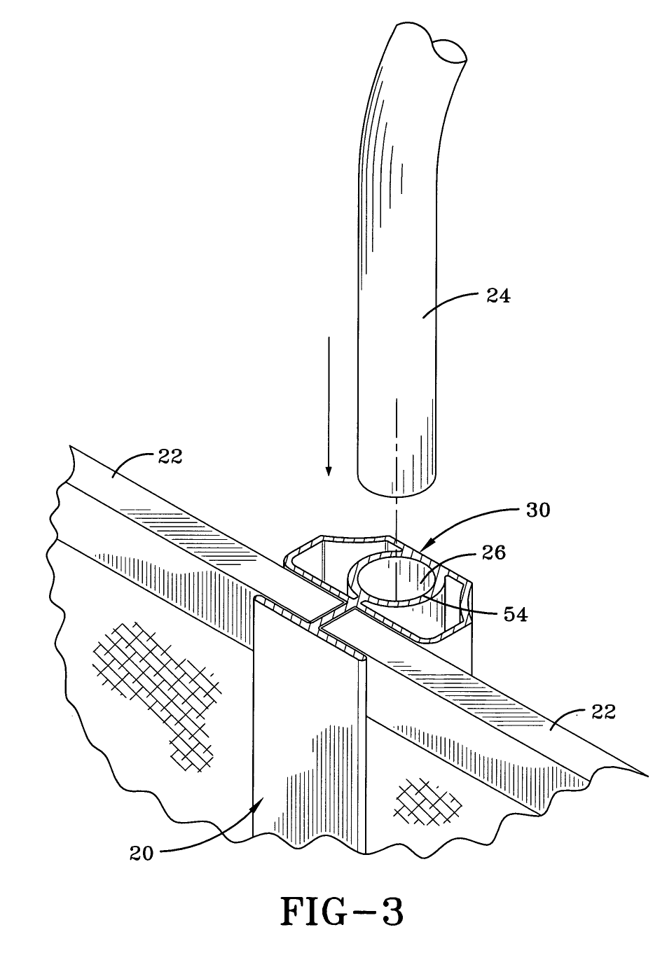

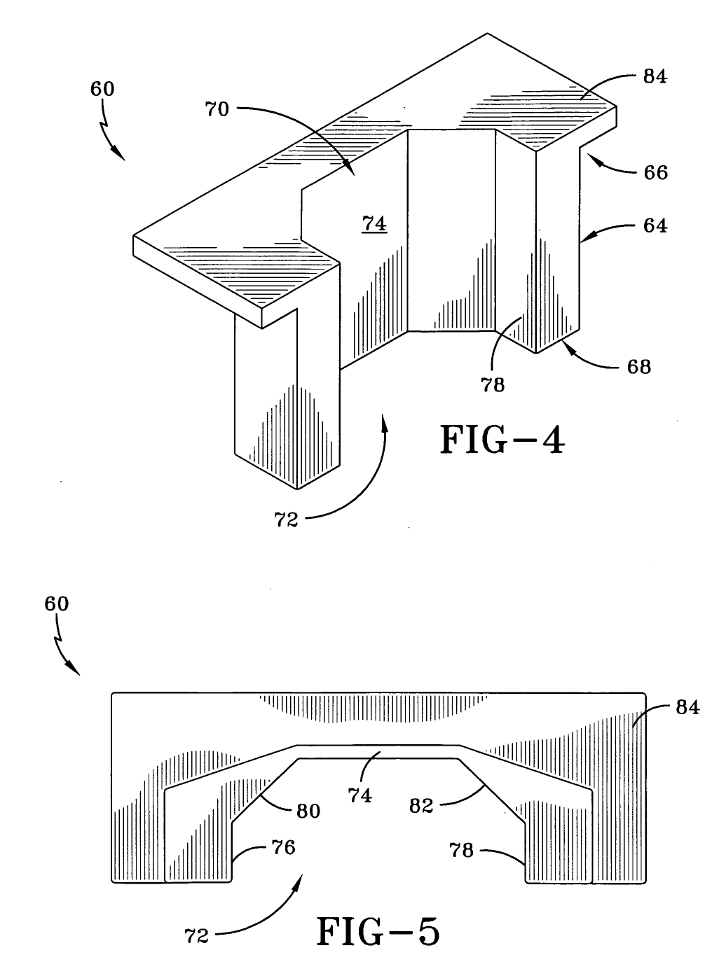

Each T-stake is provided with an insert portion 62, which is the end of T-stake 18 that is inserted into pockets 14. The remainder of T-stake 18 is exposed above bed 16 of trailer 12. A universal sleeve generally indicated by the numeral 60 may be attached to the insert portion and includes a body 64 with a top end 66 and a bottom end 68. A channel 70 extends longitudinally along body 64 from top end 66 to bottom end 68. Channel 70 forms an opening 72 on one side of body 64, giving sleeve 60 a generally U-shaped profile. Channel 70 may have an inner profile shaped to receive insert portion 62 of T-stake 18. Thus, channel 70 may have an inner surface 74 facing opening 72, a pair of side surfaces 76, 78, and, optionally, a pair of transition surfaces 80, 82 extending from side surfaces 76, 78 to inner surface 74. As a result, as best seen in FIG. 2, inner surface 74 of sleeve 60 abuts front surface 34 of T-stake 18, and side surfaces 76, 78 of sleeve 60 abut side surfaces 36, 38 of T-stake 18. Sleeve 60 may also include an outwardly extending flange 84 at top end 66. Flange 84 may extend from three sides of body 64, excluding the side having opening 72.

Insert portion 62 of T-stake 18 fits within sleeve 60, with wall retaining portion 20 extending away from inner surface 74. Sleeve 60 may be attached to insert portion 62 by any means know to persons skilled in the art, such as, for example, by welding. The attachment method should provide a strong connection between sleeve 60 and T-stake 18 so that the integrity of the side wall system 10 will be maintained during rough travel of trailer 12. Once T-stake 18 and sleeve 60 have been secured together, sleeve 60 and insert portion 62 are placed within a pocket 14 in bed 16 of trailer 12. Flange 84 of sleeve 60 engages bed 16 of trailer 12 and holds the T-stake 18 and sleeve 60 assembly in place vertically. All of pockets 14 in trailer 12 are provided with a T-stake 18 and sleeve 60 assembly in order to provide support for wall panels 22 around the entire periphery of trailer 12.

Body 64 of sleeve 60 may be provided in any number of sizes in order to fit within pockets 14. Body 64 has an outer length and width approximately equal to the inner length and width of pockets 14 to prevent movement of T-stakes 18. While the outer dimensions of sleeve 60 may vary considerably, the inner dimensions of channel 70 remain constant so that a single size of T-stake 18 may be used in trailers 12 having varying pocket 14 sizes. In this way, the production of T-stakes 18 may be improved by increasing efficiency and reducing the high volume of inventory that must currently be maintained so as to ensure the ability to convert trailers having different pocket sizes into covered trucks. Flange 84 also provides additional support for T-stakes 18 by providing a relatively large surface area of engagement with bed 16.

In view of the foregoing, it should thus be evident that a flatbed trailer sidewall system having a sleeve for use with a T-stake as described herein accomplishes the object of the present invention and otherwise substantially improves the art.

What is claimed is:

1. A universal sleeve for use with a T-stake and a pocket of a flatbed trailer sidewall system, the universal sleeve comprising a body of a selected size to be received in the pocket of the flatbed trailer, and a channel forming an opening in said body, said channel opening being sized to receive the T-stake therein.

2. The universal sleeve of claim 2, further comprising a flange extending outwardly from said body.

3. The universal sleeve of claim 2, said channel having an inner surface facing said opening, a pair of side surfaces, and a pair of transition surfaces connecting said side surfaces to said inner surface.

4. A sidewall system for receipt in pockets of a flatbed trailer, comprising a T-stake having a post portion and a wall panel retaining portion, and a sleeve having a body of a selected size to be received in a pocket of the flatbed trailer and having a channel sized to receive said post portion of said T-stake.

5. The assembly of claim 4, said channel in said sleeve forming an opening in said body, giving said sleeve a generally U-shaped profile.

6. The assembly of claim 5, said post portion of said T-stake having an exposed portion extending along a majority of said T-stake, and an insert portion, said insert portion being received in said channel of said sleeve.

7. The assembly of claim 6, said wall panel retaining portion extending longitudinally along said exposed portion of said T-stake.

8. The assembly of claim 7, said channel in said sleeve having an inner surface facing said opening, a pair of side surfaces, and a pair of transition surfaces connecting said side surfaces and said inner surface.

9. The assembly of claim 4, said sleeve being attached to said T-stake.

10. The assembly of claim 4, further comprising wall panels adapted to be received by said wall panel retaining portions of said T-stakes.

11. The sidewall system of claim 10, said post of said T-stake having a recess therein at an end opposite said sleeve.

12. The sidewall system of claim 11, further comprising an arched roof member adapted to be received in said recess in said post, and a roof tarpaulin supported by said arched roof member.

13. A method of constructing a sidewall system for a flatbed trailer having pockets comprising the steps of providing a plurality of sleeves of a size selected dependent on the size of the pockets of the flatbed trailer, providing a plurality of T-stakes adapted to fit within a channel in the sleeves which is sized to receive the T-stakes, attaching the sleeves to the T-stakes, and inserting the sleeves and the T-stakes into the pockets of the flatbed trailer.

14. The method of claim 13, further comprising the steps of providing a plurality of wall panels sized to fit between adjacent T-stakes, and inserting the wall panels between the T-stakes.

15. The method of claim 14, the T-stakes including a recess therein, the method further comprising the steps of providing a plurality of arched roof members, and inserting the arched roof members into the recesses in the T-stakes to form a roof frame.

16. The method of claim 15, further comprising the steps of providing a tarpaulin and attaching the tarpaulin over the roof frame.

17. A method of attaching a sidewall system to a flatbed trailer having pockets comprising the steps of providing a plurality of sleeves having different sized bodies and the same shaped channels, selecting sleeves having a body sized to fit within the pockets of the trailer, and attaching T-stakes shaped like the channel of the selected sleeves to the selected sleeves.
